(19) United States
(12) Patent Application Publication
(10) Pub. No.: US 2017/0174526 A1
(43) Pub. Date: Jun. 22, 2017

(54) COMPOSITE NANOMATERIALS AND MICROMATERIALS, FILMS OF SAME, AND METHODS OF MAKING AND USES OF SAME

(71) Applicant: The Research Foundation for The State University of New York, Amherst, NY (US)

(72) Inventors: Sarbajit BANERJEE, Bryan, TX (US); Kate E. PELCHER, Snyder, NY (US)

(21) Appl. No.: 15/304,953

(22) PCT Filed: Apr. 20, 2015
(86) PCT No.: PCT/US2015/026623

§ 371 Date: Oct. 18, 2016

Related U.S. Application Data
(60) Provisional application No. 61/981,667, filed on Apr. 18, 2014.

(51) Int. Cl. C01G 31/02; E06B 3/67; C03C 17/25; E06B 9/24; C03C 14/00; C03C 17/00

(52) U.S. Cl. CPC C01G 31/02; C03C 14/002; C03C 17/008; C03C 17/25; E06B 9/24; E06B 3/6722; C01P 2004/16; C01P 2004/84; C03C 2214/03; C01P 2002/77; C01P 2002/72; C01P 2004/03; C01P 2004/04; C01P 2002/82; C01P 2002/88; C03C 2217/475; C03C 2217/218; C03C 2217/213; C03C 2217/452; C03C 2218/112; E06B 2009/2417

(57) ABSTRACT

Composite nano- and micromaterials and methods of making and using same. The composite materials comprise crystalline materials (e.g., binary and ternary vanadium oxides) in an amorphous or crystalline material (e.g., oxide, sulfide, and selenide materials). The materials can be made using sol-gel processes. The composite materials can be present as a film on a substrate. The films can be formed using preformed composite materials or the composite material can be formed in situ in the film forming process. For example, films of the materials can be used in fenestration units, such as insulating glass units deployed within windows.

### CROSS-REFERENCE TO RELATED APPLICATIONS

This application claims priority to U.S. provisional patent application No. 61/981,667, filed Apr. 18, 2014, the disclosure of which is incorporated herein by reference.

### STATEMENT REGARDING FEDERAL FUNDING

This invention was made with government support under Grant No. IIP 1311837 awarded by the National Science Foundation. The government has certain rights in the invention.

### FIELD OF THE DISCLOSURE

The present disclosure generally relates to composite nanomaterials and micromaterials. More particularly, the disclosure relates to crystalline, composite nanomaterials and micromaterials encapsulated in an amorphous material.

### BACKGROUND

Because of the unique properties (e.g., physical, chemical, mechanical, and optical) possessed by materials at the nano- and microscale level, it is sometimes necessary and/or desirable to coat substrates with such materials in order to achieve commercial applicability. Key considerations for such coatings are that they are durable, well-adhered to the substrate, and that the process does not adversely impact the desirable properties of such materials.

One example of a nano- or microscale material that exhibits desirable properties and which could find commercial applications as a coating on various substrates (e.g., glass) is vanadium oxide. Vanadium oxide undergoes a reversible insulator—metal phase transition in response to increasing temperature with the specific switching temperature being tunable as a function of size and dopant concentration. The phase transition is accompanied by alteration of optical transmittance; the low-temperature monoclinic phase of VO₂ is infrared-transmissive, whereas the high-temperature rutile phase is infrared-reflective.

### BRIEF SUMMARY OF THE DISCLOSURE

In an aspect, the present disclosure provides composite nanomaterials and micromaterials (e.g., vanadium oxide nanomaterials and micromaterials). The composite materials comprise nano- and micromaterials encapsulated in an amorphous or crystalline (e.g., semicrystalline, polycrystalline, or single crystalline) material. The nano- and micromaterials are crystalline. The amorphous material or crystalline material is an oxide, sulfide, or selenide. The nano- or microcomposite materials can be present in the form of a film on a substrate.

In an aspect, the present disclosure provides methods of making the composite nano- or micromaterials. The methods are based on, for example, formation of an amorphous material using sol-gel chemistry (e.g., a modified Stöber process).

In an aspect, the present disclosure provides methods of forming a film of the composite nano- or microcomposite materials on a substrate. The methods are based on, for example, in situ formation of the composite nano- or micromaterials as part of the deposition process or formation of the nano- or microcomposite materials prior to deposition of the film.

In an aspect, the present invention provides coating formulations. In an embodiment, the coating formulation is comprised of at least one core nano- or micromaterial, at least one shell source, and a catalyst within a mixture of water and a first solvent.

In an aspect, the present invention provides kits for preparing coating formulations. In an embodiment, a kit comprises at least one core nano- or micromaterial, and at least one shell or matrix source. Optionally, the kit may further contain any or all of the following: a catalyst, a first solvent (e.g., alcohol) and water. The kits may further comprise instructions for the preparation and use of its components, alone or in conjunction with materials supplied by the purchaser.

In another aspect the present disclosure provides articles of manufacture comprising one or more of the compositions (e.g., a film comprising one or more of the compositions) disclosed herein. For example, the article of manufacture is a fenestration component such as a window unit, skylight, or door. In an embodiment, the fenestration component is a thermoresponsive window (e.g., as shown in FIGS. 2A and 2B).

### BRIEF DESCRIPTION OF THE FIGURES

FIG. 1A. Low-temperature monoclinic phase of VO₂. FIG. 1B. High-temperature tetragonal phase of VO₂.

FIG. 2A. Schematic of a thermoresponsive “smart window”, which is equipped with the ability to block transmission of infrared radiation at high temperatures while allowing transmission of infrared light at low temperatures, all while maintaining transparency in the visible region of the electromagnetic spectrum. FIG. 2B. Illustrative example of a prototype insulating glass unit.

FIG. 3A. XRD pattern of as-prepared VO₂ nanowires indexed to the monoclinic crystal structure. FIG. 3B. SEM image of as-prepared VO₂ nanowires.

FIGS. 4A-4F. SEM images. FIG. 4A shows as-prepared VO₂ nanowires. FIG. 4B shows 15 minute reacted VO₂ nanowires. FIG. 4C shows 30 minute reacted VO₂ nanowires. FIG. 4D shows 60 minute reacted VO₂ nanowires. FIG. 4E shows EDX spectra of 30 minute reacted VO₂ nanowires. FIG. 4F shows 60 minute reacted VO₂ nanowires.

FIGS. 5A-5D. TEM images. FIG. 5A shows uncoated VO₂ nanowires. FIG. 5B shows 15 minute reacted VO₂ nanowires. FIG. 5C shows 30 minute reacted VO₂ nanowires. FIG. 5D shows 60 minute reacted VO₂ nanowires.

FIGS. 6A-6B. SEM images. FIG. 6A shows 30 minute reacted VO₂ nanowires annealed in air. FIG. 6B shows 30 minute reacted VO₂ nanowires annealed under argon.

FIGS. 7A-7D. TEM images. FIG. 7A shows 30 minute reacted VO₂ nanowires annealed in air. FIG. 7B shows 30 minute reacted VO₂ nanowires annealed under argon. FIG. 7C shows 60 minute reacted VO₂ nanowires annealed in air. FIG. 7D shows 60 minute reacted VO₂ nanowires annealed under argon.

FIGS. 8A-8B. Raman spectra. FIG. 8A shows spectra for 30 minute reacted VO₂ nanowires. FIG. 8B shows spectra for 60 minute reacted VO₂ nanowires.

FIGS. 9A-9B. DSC spectra. FIG. 9A shows spectra for 30 minute reacted VO₂ nanowires. FIG. 9B shows spectra for 60 minute reacted VO₂ nanowires.

FIG. 10A shows images of coated slides. FIG. 10B shows images of coated slides after wipe test. FIG. 10C shows images of coated slides after wash.

FIG. 11A Top-view and FIG. 11B cross-sectional view of VO₂ nanowires embedded in an amorphous SiO₂ matrix bonded to glass.

FIG. 12. The top panel shows spray-coated VO₂ nanowires on a glass surface before and after peeling tape as per ASTM 3359 (ASTM International's Standard Test Methods for Measuring Adhesion by Tape Test). Significant flaking is observed and the peeled sample is assigned a grade of 0B. In contrast, the VO₂/SiO₂ samples with (middle panel) and without (lower panel) annealing at 100° C. exhibit desirable adhesion and are classified as 5B.

FIG. 13A NIR transmittance in the range between 2500 and 4200 nm indicating the transmittance is sharply decreased with increasing temperature with a pronounced discontinuity evidenced at the phase transition temperature of 67° C. FIG. 13B A more expansive IR spectrum spanning from 1000 to 7000 nm indicating the change in optical transmittance is most pronounced in the 1000 to 3000 nm range, which is well matched with the solar spectrum.

FIG. 14. Reaction Scheme I: Process of making SiO₂ shelled VO₂ nanowires.

### DETAILED DESCRIPTION

It is an object of the present disclosure to provide composite nanomaterials and micromaterials and composite nanomaterial and micromaterial coated substrates. Also, it is an object of the present disclosure to provide methods of making the materials and uses of the materials.

Unlike the bulk or vapor-deposited thin films, metal oxide, e.g., VO₂, nano- and micromaterials can be cycled thousands of times without degradation in properties (cracking or fracture) due to the facile relaxation of mechanical strain as a result of the finite size of the materials. The materials prepared by our synthetic route are available as free-standing solution-dispersible high-purity powders, allowing them to be coated by a variety of standard glass-coating methods such as spray coating, powder coating, and roller application.

The present disclosure addresses two impediments to the integration of these materials, e.g., VO₂ nano- and microwires within functional thermochromic coatings. First, increased chemical and thermal stability is desirable for the coating materials since the materials can readily be oxidized, e.g., to V₂O₅ that represents a thermodynamic sink in the binary V—O system. For example, although, most envisioned glazing applications would place the material coatings on the interior surface of double-paned insulating glass units, increased chemical and thermal stability would help make these materials consonant with the stringent long term warranties offered by most insulating glass unit manufacturers. A second problem is that as-prepared materials may not adhere well to some surfaces, e.g., glass surfaces.

Both of these issues are addressed by encapsulating the materials with, for example, amorphous silica shells or dispersing the materials in an amorphous silica matrix. The silica enhances the adhesion of the nano- or microwires to glass substrates. In our laboratory, the silica shells on the VO₂ nanowires have been characterized by scanning electron microscopy (SEM) and transmission electron microscopy (TEM) before and after annealing. Differential scanning calorimetry (DSC) and Raman experiments were further used to demonstrate that the silica coating does not change the transition temperature of the nanowires, and indeed suggests that the coatings protect the nanowires from oxidation. This coating method has further been used to prepare, for example, a coating of the VO₂@SiO₂ nanowires on the surfaces of glass substrates. The coated substrates exhibit substantial switching of infrared transmittance as a function of temperature. Also VO₂ nanowires were separately shelled with TiO₂ shells and VO₂ shells to enhance anti-reflective properties. Likewise, we have separately dispersed VO₂ nanowires in TiO₂ and VO₂ matrices. Another way by which the attachment of the nanowires to the substrate was improved was by hydroxylating the substrate or by selecting a substrate which natively possess a sufficient number of surface hydroxyl groups to bond to the silica shell.

In an aspect, the present disclosure provides composite nanomaterials and micromaterials. The composite nanomaterials and micromaterials are heterostructured, i.e., they are comprised of two materials and there is no exogenous interfacial material at the interface of the two materials. The composite materials may be ceramic composite materials or heterostructured materials (e.g., heterostructured oxide materials). The composite materials comprise nano- and/or micromaterials (e.g., oxide nano- and/or micromaterials) encapsulated in an amorphous or crystalline (e.g., semicrystalline, polycrystalline, or single crystalline) material. The nano- and micromaterials are crystalline. The nano- and micromaterials are also referred to herein as core nanomaterials and core micromaterials. The amorphous or crystalline material are also referred to herein as a shell (or shell material) or core-shell (or core-shell material). For example, the crystalline nano- and micromaterials are oxide nano- and micromaterials dispersed in an amorphous or crystalline oxide, sulfide, and/or selenide material (e.g., a coating or matrix). In an embodiment, the composite nano- and micromaterials are those made by a method of the present disclosure.

The present invention uses any inorganic nano- or micromaterial capable of being coated with a shell or being encapsulated in a matrix selected from the group consisting of SiO₂, TiO₂, VO₂, V₂O₅, ZnO, HfO₂, CeO₂, B(OH)₃ and MoO₃. The inorganic nano- or micromaterial must possess or be modified to possess hydroxides on its surface. The nano-material has at least one structural dimension less than 100 nm. The micro-material has no structural dimension less than 100 nm and at least one structural dimension is less than 100 μm.

In an embodiment, the inorganic nano- or micromaterial is an oxide such as vanadium oxide. The term “vanadium oxide” includes: (a) binary vanadium oxides with the formula: (i) VₓO₂ₓ (e.g., VO₂) and/or VₓO₂ₓ₊₁ (e.g., V₂O₅ and V₃O₇), where x is an integer from 1 to 10, including all integers therebetween; and (b) ternary vanadium oxide bronzes with the formula MₓV₂O₅, where M is selected from the group consisting of Cu, K, Na, Li, Ca, Sr, Pb, Ag, Mg, and Mn, and where x ranges from 0.05 to 1, including all values to 0.01 and ranges therebetween. In another embodiment, the inorganic nano- or micromaterial is vanadium oxide doped with metal cations and, optionally, heteroatom ions, as described in U.S. patent application Ser. No. 13/632,674, which is hereby incorporated by reference. Dopants include molybdenum, tungsten, titanium, tantalum, sulfur, and fluorine. Doping concentration can reach 5%. In an embodiment, the doping range is 0.05% to 5% by weight.

The nano- or micromaterial (e.g. vanadium oxide) can have a single domain or multiple electronic domains. The nano- or micromaterial (e.g. vanadium oxide) can be single crystalline nano- or microparticles. In an embodiment, the vanadium oxide nano- or microparticles are VO₂ nano- or microparticles. In another embodiment, the vanadium oxide nano- or microparticles are V₂O₅ nano- or microparticles with or without intercalating cations. The nano- or microparticles can be present in a variety of polymorphs. The nano- or microparticles can be present in a variety of structures. In an embodiment, the vanadium oxide nano- or microparticles exhibit a metal-insulator transition at a temperature of −200° C. to 350° C. Other suitable nano- or micromaterials for use in the coatings, coated substrates and methods of the present invention include Ag, Au, CdSe, Fe₂O₃, Fe₃O₄, Mn₂O₃, Pt, SiC, and ZnS and heterostructures incorporating one or more of these components.

The nano- or micromaterial may possess any morphology. Suitable morphologies include but are not limited to nano- or microparticles, nano- or microwires, nano- or microrods, nano- or microsheets, nano- or microspheres, and nano- or microstars.

The nano- or micromaterial may be made by hydrothermal reduction followed by solvothermal reduction, as in Example 1 (VO₂). In particular, nanomaterials may be formed when the solvothermal reduction reaction is run for 48-120 hours, while micromaterial may be formed when the solvothermal reduction reaction is run for 24-48 hours. Analogous to VO₂, vanadium oxide bronzes with the formula MₓV₂O₅ (where M is a metal cation) can be synthesized through a similar hydrothermal route by using a metal oxalate, nitrate, or acetate with V₂O₅ powder in the presence of an appropriate structure directing agent. Examples of structure directing agents include 2-propanol, methanol, 1,3-butanediol, ethanol, oxalic acid, citric acid, etc. The mole percent of metal to vanadium can vary from 1% to 66%. The reactants are mixed with 16 mL of water and reacted at pressures ranging from 1500-4000 psi for 12-120 hours. Nano- or micromaterials can also be made by solid-state reactions, chemical vapor deposition, microwave synthesis or sol-gel reactions.

The nano- and micromaterials are encapsulated in an amorphous or crystalline material. The amorphous material is an oxide, sulfide, or selenide. Examples of suitable materials include main group or transition metal chalcogenides and oxides. The materials can be deposited by solution-phase or vapor deposition methods. In an embodiment, the material conformally coats the crystalline nano- and micro-oxide materials. The material can be referred to as a matrix or a shell. The material is also referred to herein as a coating. In an embodiment, the exterior surface of amorphous or crystalline material has a plurality of hydroxyl groups on the surface. The materials may be a mixtures of, for example, amorphous and/or crystalline oxides, sulfides, and/or selenide materials. Examples of oxide materials include SiO₂, TiO₂, VO₂, V₂O₅, ZnO, HfO₂, CeO₂, MoO₃, and combinations thereof. Examples of sulfides include FeS, MoS₂, CuS, CdS, PbS, VS₂, and combinations thereof. Examples of selenides include FeSe, MoSe₂, CuSe, CdSe, PbSe, VSe₂, SbₓSe₁₋ₓ (where x is 0.1 to 0.99) and combinations thereof. An oxide material can be reacted by methods known in the art to provide sulfide material, selenide material, or a mixture of oxide and sulfide or amorphous oxides and selenides.

The nano- or microcomposite materials can be present in the form of a film on a substrate. In an embodiment, the present invention provides a substrate comprising a film of the nano- or micro-oxide composite materials or the composition comprising the materials. The film is disposed on at least a portion of a surface of the substrate. The substrate can be any of those disclosed herein. Any substrate whose surface is or can be hydroxylated serves as a suitable substrate. For example, the substrate is glass, sapphire, alumina, a polymer or plastic (e.g., acrylic, plexiglass, poly(methyl methacrylate) (PMMA), or polycarbonate), or indium tin oxide-coated glass. The substrate may be flexible. The film can have a variety of thicknesses. For example, has a thickness of 10 nm to 5 microns, including all nm values and ranges therebetween.

Films can have a rough, periodically arrayed, or ordered surface or a smooth surface. The films may form part of a multilayered architecture.

In an aspect, the present disclosure provides methods of making the composite nano- or micromaterials. The methods are based on, for example, formation of the amorphous oxide, sulfide, or selenide material using sol-gel chemistry. The amorphous or crystalline oxide, sulfide, or selenide material is formed from a precursor. The precursor is also referred to herein a shell source, matrix source, or encapsulating material precursor.

For example, using a modified Stöber process, constitution of conformal SiO₂ shells around the VO₂ nanowires was demonstrated. The SiO₂ shells enhanced the robustness of the VO₂ nanowires towards thermal oxidation and furthermore improved the adhesion of the nanowires to glass substrates. The thickness of the shells was observed to depend on the reaction time. Notably, the deposition of conformal shells did not deleteriously impact the metal-insulator transitions of the VO₂ nanowire cores.

In an embodiment, the composite nano- or microcomposite materials are made by contacting nano- or micromaterials with a precursor (e.g., a sol-gel precursor such as a metal alkoxide) under conditions such that the composite nano- and micromaterials are formed. A covalent linkage is established by condensation of —OH or related (—NH₂, —COOH, -epoxide) moieties on the nanomaterial or micromaterial surface with, for example, the sol-gel precursor. The formation of metal-oxygen-metal bonds covalently embeds the nanomaterial within the amorphous or crystalline material.

In an aspect, the present disclosure provides methods of forming a film of the composite nano- or microcomposite materials on a substrate. The methods are based on, for example, in situ formation of the composite nano- or micromaterials as part of the deposition process or formation of the nano- or microcomposite materials prior to deposition of the film.

The methods of the present invention may involve preparation of at least a portion of the surface of substrates for coating with nano- or micromaterials, wherein said preparation results in the addition and/or exposure of hydroxyl groups on the surface of said substrate(s). Suitable preparation protocols include use of hydroxylating solutions (e.g. superoxides, strongly basic solutions, certain cleaning solutions, etc.), contacting at least part of the surface of the substrate with a plasma gas containing a reactive hydroxylating oxidant species, electrochemical treatment (e.g. in basic media, electro-Fenton reaction, etc.), exposure to ozone, or any combination thereof.

Any substrate whose surface is or can be hydroxylated serves as a suitable substrate. By way of example and without limitation, suitable substrates include glass, indium-tin oxide coated glass, aluminum, sapphire, ceramics, plastics (e.g., acrylic, PET, PMMA, polycarbonate), and sapphire.

In an embodiment, the present invention provides a method for coating at least a portion of the surface of a substrate with a nano- or micromaterial comprising the steps: (a) preparing at least a portion of the surface of a substrate, wherein preparation results in the addition and/or exposure of hydroxyl groups on the surface of said substrate, (b) preparing a solution comprising: at least one core nano- or micromaterial, at least one shell source, and a catalyst in a mixture of: (i) a first solvent, and (ii) water, (c) allowing the solution described in (b) to react, and (d) coating the surface prepared in (a) with at least a portion of the reacted solution resulting from (c). Step (d) may optionally be repeated one or more times to achieve the desired coating thickness. The above method may further comprise an annealing step following step (d) or any repetitions thereof.

Alternatively, the substrate may natively possess a sufficient number of surface hydroxyl groups to bond to the shell or matrix, so hydroxylation of the substrate in step (a) is unnecessary and not performed.

In another embodiment, the present invention provides a method for coating at least a portion of the surface of a substrate with a nano- or micromaterial comprising the steps: (a) preparing at least a portion of the surface of a substrate, wherein preparation wherein said preparation results in the addition and/or exposure of hydroxyl groups on the surface of said substrate(s), (b) providing a dispersion of core-shell nano- or micromaterials, and (c) coating the surface prepared in (a) with the dispersion provided in (b).

Alternatively, the substrate may natively possess a sufficient number of surface hydroxyl groups to bond to the shell or matrix so hydroxylation of the substrate in step (a) is unnecessary and not performed.

In another embodiment, a method of making a substrate comprising the composition (e.g., composite vanadium oxide nano or micromaterial) disposed on at least a portion of a surface of the substrate comprises: a) optionally, forming a plurality of hydroxyl groups on the at least a portion of a surface of the substrate; and b) contacting the at least a portion of a surface of the substrate with a film forming composition such that the composition is formed on the at a portion of the surface of the substrate; and c) optionally, repeating b) (i.e., contacting the substrate from b) with the film forming composition) until a desired thickness of the composition is formed on the at least a portion of the surface of the substrate is formed. The film forming composition can comprise preformed composite nano- or micromaterials (e.g., composite vanadium oxide nano or micromaterials). Optionally, the film forming composition comprises nanomaterial or micromaterial (e.g., vanadium oxide nano or micromaterial), encapsulating material precursor, a catalyst, and an aqueous solvent, where the encapsulating material precursor reacts to form the amorphous material. For example, the layer of the composition on at least a portion of the surface of the substrate is formed by spray coating, spin coating, roll coating, wire-bar coating, dip coating, powder coating, self-assembly, or electrophoretic deposition. Optionally, the method further comprises annealing the composition formed on the at least a portion of the surface of the substrate in b) and/or after at least one of the compositions is formed on the at least a portion of the surface of the substrate in c). For example, the hydroxyl groups are formed by contacting the at least a portion of the substrate with a hydroxylating solution, ozone, or a plasma comprising a hydroxylating oxidant species.

In some embodiments, it is desirable to coat the substrate with a single, unique core-shell or matrix-forming nano- or micromaterial (e.g., vanadium oxide nano- or microwires and silica shell/matrix).

In other embodiments, it is desirable to coat the substrate with two or more unique core-shell or matrix-forming nano- or micromaterials (e.g., vanadium oxide nano- or microwires and silica shell/matrix and vanadium oxide nano- or microwires and titanium dioxide shell/matrix).

The selection of a shell or matrix source depends on the material(s) desired for the shell or matrix. Silica sources can be selected from metal alkoxides, such as tetraethyl orthosilicate (TEOS), tetramethyl orthosilicate (MEOS), or any other orthosilicate or inorganic salts such as sodium silicate (Na₂SiO₃). The amount of silica source can vary from 0.45% to 5% of the total reaction solution. Titanium dioxide sources can be selected from tetrabutyl titanate (TBOT), tetraethyl titanate, tetrapropyl orthotitanate, and tetraisopropyl orthotitanate. The amount of titania source can vary from 0.2% to 5% of the total reaction solution. Vanadium oxide sources can be selected from any vanadium oxide. The moles of vanadium in the source can vary from 5 mM to 5 M. Zinc oxide sources can be selected from zinc acetate dehydrate and can vary in concentration from 5 mM to 5M. For CeO₂, cerium (IV) isopropoxide, cerium (IV) tert-butoxide, cerium oxalate, and cerium (IV) methoxyethoxide can be used as cerium oxide sources and can vary in concentration from 5 mM to 5M. For HfO₂, Hf(IV) alkoxides can be used with the general formula Hf(OR)₄ where R is a straight or branched alkyl chain, aromatic group, or heterocylic group. Examples include hafnium(IV) isopropoxide, Hf(IV) tert-butoxide, hafnium ethoxide, Hf(IV) n-butoxide, Hf(IV) hexoxide, Hf(IV) phenoxide, etc. The Hf precursors can vary in concentration from 5 mM to 5M. For MoO₃, Molybdenum(V) ethoxide and molybdenum(V) isopropoxide can be used as molybdenum oxide sources and vary in concentration from 5 mM to 5M. Modifications of synthetic conditions and reaction temperatures may be required to optimize deposition of shells or matrix formation in each instance.

The catalyst can be an acid or base catalyst such as a strong or weak acid or base. Examples of suitable catalysts include NH₃ (anhydrous), hydroxide salts, ammonium salts (e.g., 28-30% ammonium hydroxide (NH₄OH)), HCl, organic amines, primary amines, secondary amines or tertiary amines, or a combination thereof, and can make up from 0.1% to 5% of the total reaction solution.

The first solvent may be ethanol, methanol, n-propanol, tetrahydrofuran, dimethylsulfoxide, or isopropanol.

In an embodiment, the first solvent (e.g., ethanol) and water are present in a ratio ranging from 1:1 to 20:1. The reaction rate can be controlled through the ratio of water to the first solvent and by varying temperature. Increasing the ratio of water to the first solvent or heating the solution increases the reaction rate. Solutions containing methanol should not be heated above 60° C. while those with isopropanol and/or ethanol should not be heated above 80° C.

The thickness of the amorphous oxide matrix and/or composite film can be controlled by, for example, the ratio of reactants, the reaction time, the nanomaterial/micromaterial loading, added inhibitors or catalysts, and/or reactant concentrations. Generally, longer reaction times and reaction concentrations provide thicker films.

The annealing can be conducted at a temperature of from 50° C. to 150° C. Annealing can be done in open air or in the presence of argon and facilitates the removal of excess H₂O from the coatings as well as increased cross-linking of the covalent Si—O—Si network.

In various embodiments, the adhesion of the coating is classified as at least a 3B using ASTM D3359. In a preferred embodiment, the adhesion is classified as a 5B.

Numerous methods of cleaning glass substrates can be used, including using gas plasmas, and combinations of acids, bases and organic solvents that are allowed to react at varying temperatures. In an example, washing with basic peroxide followed by acidic peroxide both cleans and hydroxylates the surface of glass substrates. Other suitable hydroxylating solutions include piranha solution (a 3:1, 4:1 or 7:1 mixture of sulfuric acid (H₂SO₄) and hydrogen peroxide (H₂O₂)), base piranha solution (where ammonium hydroxide (NH₄OH) is substituted for sulfuric acid), hydrofluoric acid (HF) wherein the concentration ranges from 0.01 to 3M, and caustic solutions of KOH/ethanol. Reaction of the substrate with the cleaning solution (e.g. piranha solution) can range from 30 minutes to 24 hours. Following preparation with one or more hydroxylating solutions, the substrate should be rinsed with electrolyte-free water such as deionized water or nanopure water.

The term “plasma gas” as used throughout the specification is to be understood to mean a gas (or cloud) of charged and neutral particles exhibiting collective behavior which is formed by excitation of a source of gas or vapor. A plasma gas containing a reactive hydroxylating oxidant species contains many chemically active plasma gases charged and neutral species which react with the surface of the substrate. Typically, plasma gases are formed in a plasma chamber wherein a substrate is placed into the chamber and the plasma gases are formed around the substrate using a suitable radiofrequency or microwave frequency, voltage and current.

The reactive hydroxylating oxidant species that is included in the plasma gas may be any agent that is able to form hydroxyl groups on the surface of the substrate. Example reactive hydroxylating oxidant species are hydrogen peroxide, water, oxygen/water or air/water. In a preferred embodiment of the present disclosure, the reactive hydroxylating oxidant species is hydrogen peroxide.

The rate and/or extent of reaction of the plasma gas containing the reactive hydroxylating oxidant species and the substrate can be controlled by controlling one or more of the plasma feed composition, gas pressure, plasma power, voltage and process time.

In another embodiment, the substrate is treated with ozone gas either using a solution phase ozonator or an ozone chamber. Ozone treatment can be performed with or without UV exposure for times ranging from 10 seconds to 120 minutes.

The degree of surface hydroxylation depends on factors such as the type (bridged or terminal) and density of hydroxyl groups. The degree of surface hydroxylation can range from 1 of 1,000 surface sites to every accessible surface site (submonolayer to monolayer coverage). Additionally, the desired degree of hydroxylation resulting from the preparation method(s) disclosed herein can be controlled by altering the duration of exposure (longer times result in increased hydroxylation) to said method(s), concentration of active reactants (higher concentrations result in increased hydroxylation), and reaction temperature (higher temperatures lead to increased hydroxylation).

Suitable techniques for coating substrate surfaces using the methods of the present invention include, but are not limited to spray, spin, roll, wire-bar, and dip coating. Choice of technique is, in part, dependent on the desired and/or required coating thickness. For example, spin coating typically results in few tens or hundreds of nanometers thick (50 to 600 nm) layers being deposited. Coating thicknesses can also be controlled through the practice of one or more coating steps. For example, practice of multiple coating steps will result in thicker coatings.

Spray coating requires a low-viscosity (0 to 2,000 centipoise (cP)) sample that is composed of a well-dispersed material in a solvent. Coating thickness is controlled by repetitions. Dip coating can be used on viscous samples as well as low-viscosity samples by varying the rate of extraction. Spin and roll coating both require high viscosity (greater than 2,000 cP) samples, which in combination with spin speed or bar selection, respectively, alters the thickness of the coating.

In an aspect, the present invention provides coating formulations. In an embodiment, the coating formulation is comprised of at least one core nano- or micromaterial, at least one shell source, and a catalyst within a mixture of water and a first solvent, wherein the ratio of water to the first solvent (e.g. ethanol) ranges from 1:1 to 1:20. The shell or matrix source(s) depends on the material(s) desired for the shell or matrix (see above). The first solvent can be ethanol, methanol, n-propanol, tetrahydrofuran, dimethylsulfoxide or isopropanol. In one example, the nano- or micromaterials are VO₂ nano- or microwires, the silica source is TEOS, the catalyst is NH₄OH, the first solvent is ethanol, and the ratio of water to the first solvent (ethanol) is 1:4.

In an embodiment, the present invention provides a method for preparing a nano- or micromaterial coating solution, comprising the steps: (a) preparing a solution comprising: at least one core nano- or micromaterial, at least one shell source, and a catalyst in a mixture of: (i) a first solvent, and (ii) water, (c) allowing the solution described in (b) to react and form core-shell nano- or microparticles dispersed in a solvent.

In another embodiment, the nano- or micromaterial coating is comprised of core-shell nano- or micromaterials (e.g. VO₂@SiO₂) dispersed within a fast evaporating solvent such as isopropanol. Other suitable solvents include ethanol and methanol.

For example, a coating method to apply thin films onto glass by spray-coating was developed. The modified Stöber process is followed by spray-coating a substrate after 10 minutes. The substrate and the Stöber process mixture react to form the nano- or micromaterial dispersed in a matrix. We showed that the applied coatings of VO₂ nanowires dispersed in an amorphous silica matrix are strongly bonded to glass as tested using standardized ASTM methods. The coatings exhibit promising thermochromic response and are able to attenuate transmission of infrared radiation by up to 40%. Other embodiments of the coating involve dispersing VO₂ nano- or micromaterials within TiO₂ and doped VO₂ matrices. These matrices further yield anti-reflective properties. In some examples, the methods are used to coat vanadium oxide nano- or microwires on a substrate.

The steps of the methods described herein, including, for example, the various embodiments and examples disclosed herein, are sufficient to carry out the methods of the present disclosure. Thus, in an embodiment, a method consists essentially of a combination of the steps of the method disclosed herein. In another embodiment, the method consists of such steps.

In another aspect, the present invention provides kits for preparing coating formulations. In an embodiment, a kit comprises at least one core nano- or micromaterial, and at least one shell or matrix source. Optionally, the kit may further contain any or all of the following: a catalyst, a first solvent (e.g., alcohol) and water. In one example, the kit consists of vanadium oxide (e.g., VO₂) nano- or microwires, TEOS, NH₄OH, and a water and ethanol mixture in a ratio of 1:4.

In another embodiment, the kit comprises a nano- or micromaterial coating comprising core-shell nano- or micromaterials and a solvent. In another embodiment, the kit comprises a solvent, a nano- or micromaterial coating comprising nano- or micromaterials which will form a matrix upon application to the substrate. In examples of the core-shell and matrix-forming nano- or microparticles, the nano- or micromaterial is VO₂@SiO₂ and the solvent is isopropanol.

The kits may further comprise instructions for the preparation and use of its components, alone or in conjunction with materials supplied by the purchaser. The instructions may be printed materials or electronic information storage medium such as thumb drives, electronic cards, and the like. The instructions may provide any information relevant to the intended use, including safety precautions. The components of the kits may be provided in separate vials or containers within the kit.

In another aspect the present disclosure provides articles of manufacture comprising one or more of the compositions (e.g., a film comprising one or more of the compositions) disclosed herein. For example, the article of manufacture is a fenestration component such as a window unit, skylight, or door.

In an embodiment, the present disclosure provides a fenestration component comprising one or more films disclosed herein. The film(s) is/are disposed on at least a portion of a surface of the fenestration component. For example, the film(s) is/are disposed on at least a portion of a surface (e.g., a glass surface or plastic surface such as an acrylic, PET, PMMA, or polycarbonate surface) of the fenestration component. In another example, the fenestration component is a double-paned insulating glass window and a film is disposed on at least a portion of an inner surface (e.g., a glass surface or plastic surface such as an acrylic, PET, PMMA, or polycarbonate surface) of the fenestration component.

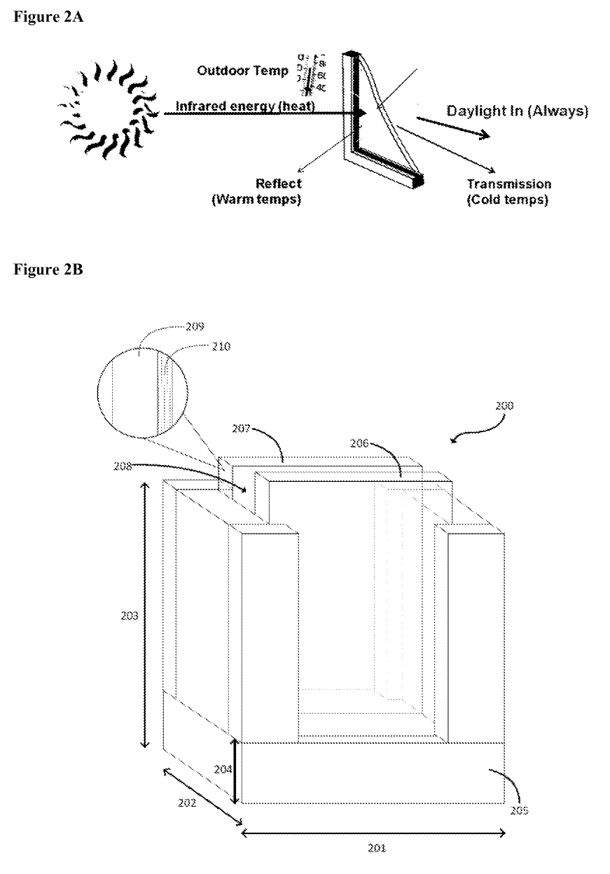

In an embodiment, the fenestration component is a thermoresponsive window. FIG. 2A illustrates a thermoresponsive “smart window” that can block transmission of infrared radiation at high temperatures and allow transmission of infrared light at low temperatures while maintaining transparency in the visible region of the electromagnetic spectrum. This smart window includes a coating which can be, for example, on one of the surfaces of the window. While a single-pane window is illustrated in FIG. 2A, other types of windows or other fenestration components can be used.

FIG. 2B illustrates an embodiment of an insulating glass unit (e.g., a window) using a coating as disclosed herein. The insulating glass unit 200 includes a first pane 206 and second pane 207 in the frame 205. A gap 208 is present between the first pane 206 and second pane 207. In an example, the first pane 206 and second pane 207 are glass, though other materials are possible.

As seen in the cross-section in FIG. 2B, the second pane 207 has a glass component 209 and a coating 210. The coating 210 can be a composition described herein. In the example of FIG. 2B, the coating 210 is disposed on the glass component 209 on a surface of the second pane 207 facing the gap 208. The coating 210 also can be disposed on a surface of the first pane 206 facing the gap 208, surfaces of both the first pane 206 and second pane 207 facing the gap 208, or other surfaces of the insulating glass unit 200.

In an example, the insulating glass unit 200 has a dimension 201 of 2.75 inches, a dimension 202 of 1 inch, a dimension 203 of 1.75 inches, and a dimension 204 of 0.5 inch. These dimensions can vary and are merely listed as examples. The insulating glass unit 200 can be, for example, scaled up or scaled down.

While illustrated in FIG. 2B as a double-pane window, this is merely an example. The insulating glass unit 200 can be other types of windows or other fenestration components such as skylights or glazed doors.

The compositions can be activated (i.e., undergo transition from transparent to IR reflective above a transition temperature). The compositions can be activated passively (e.g., by a change in ambient temperature (solar heating)) or actively (e.g., by application of a voltage or current to the composition).

The following examples are presented to illustrate the present disclosure. They are not intended to limiting in any manner.

### Example 1—Coating Glass Substrates with VO₂-Based Nanomaterials

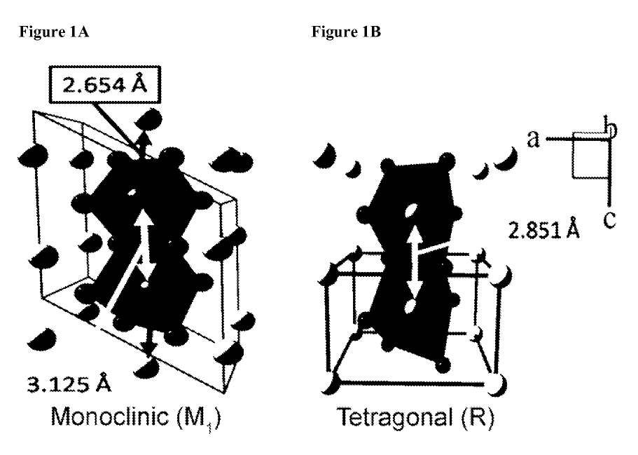

The dramatic first-order solid-solid metal-insulator transition of the binary vanadium oxide, VO₂, has few parallels in solid state chemistry, and is most famously characterized by an abrupt change in optical transmittance and electrical conductivity that can span five orders of magnitude. Amongst the legion of materials exhibiting metal-insulator transitions, VO₂ occupies a special place since the metal-to-insulator transition occurs in close proximity to room temperature for the bulk material (at ca. 68° C.). A structural transition is often seen to underpin the electronic phase transition although substantial controversy still rages regarding the Peierl's versus Mott-Hubbard mechanistic origin of the transition. In essence, the first-order structural phase transition transforms the material from a tetragonal rutile (R, P42/mnm) phase stable at high temperatures to a low-temperature monoclinic (M1, P21/c) phase (FIGS. 1A and 1B). During this structural transition, the uniform V—V bond length of 2.85 Å along the crystallographic c axis is altered to create alternating short and long bond distances of 2.65 and 3.13 Å, respectively, which can be viewed as “dimerization” of adjacent vanadium cations (FIGS. 1A and 1B) and results in doubling of the unit cell parameter. In addition, the alternating V—V chains adopt a zigzag configuration in the M1 phase that is substantially canted from the linear geometry of the V—V chains in the rutile phase. The phase transition is entirely reversible upon heating albeit with a pronounced hysteresis as expected for a first-order phase transition. While the precise roles of electron-phonon coupling and strong electronic correlations remains to be conclusively elucidated, the emerging consensus in the discipline appears to support a role for both driving forces.

Regardless of the precise mechanistic origin of the phase transition, the dramatic temperature-induced switchability of the optical transmittance of VO₂ lends itself to useful practical applications such as in spectrally selective thermochromic glazing technologies. Below 67° C., VO₂ has a bandgap of ca. 0.8 eV and is transparent to infrared light. Above this temperature, it transforms on a timescale quicker than 300 femtoseconds to a metallic phase and reflects infrared light, thereby serving as a heat mirror. The infrared part of the solar spectrum is primarily responsible for the heating of interiors (solar heat gain). The metallic form of VO₂ thus precludes solar heat gain and prevents the heating of interiors at high ambient temperatures, but is transformed at cooler ambient temperatures to the insulating phase, which permits solar radiation to heat the interiors.

This remarkable property portends applications in “smart window” coatings. While the “chameleon-like” dynamically switchable properties of VO₂ have long been known, practical device implementation has been hindered by the high switching temperature and the tendency of the material to crack upon cycling.

Experimental Protocol. Synthesis of VO₂ Nanowires: VO₂ nanowires were synthesized using a hydrothermal approach. First, V₃O₂ nanowires were synthesized by the hydrothermal reduction of V₂O₅ by oxalic acid. This reaction was performed at 210° C. in a Teflon-lined acid digestion vessel (Parr). Briefly, 300 mg of bulk V₂O₅ (Sigma-Aldrich) and 75 mg of oxalic acid (J. T. Baker) were mixed with 16 mL of water, sealed within an autoclave, and allowed to react for 72 h. The reaction was stopped at 24 h intervals and the reactants were mechanically agitated. In the next step, VO₂ nanowires were formed by the low-pressure (1500-1900 psi) solvothermal reduction of V₃O₂ nanowires using a 1:1 mixture of 2-propanol and water. This reaction was also performed in a Teflon-lined acid digestion vessel at 210° C. The collected powder was washed with copious amounts of water and annealed under argon at 450° C. for at least 1 h.

Silica Coating of VO₂ Nanowires: A modified Stöber Method was used to coat the VO₂ nanowires with an amorphous silica shell. Ethanol and DI water were used as solvents. Briefly, tetraethylorthosilicate (TEOS, Alfa Aesar) and NH₄OH (28%-30%, JT Baker) were used as received. In a typical reaction, 24 mg of VO₂ nanowires were ultrasonicated in a solution of 32 mL of ethanol and 8 mL of water. After 5 min, 400 μL of NH₄OH solution was added dropwise to this dispersion. NH₄OH acts as a catalyst and maintains the hydroxide concentration in solution (Journal of American Science 2010, 6, 985-989). After 10 min, 200 μL of TEOS was added dropwise to the solution. The solution was then allowed to react for different periods of time to control the shell thickness. To terminate the reaction, the solution was centrifuged and the collected powder was washed, redispersed in ethanol, and then centrifuged again to collect the powder. A total of 4-6 centrifugation cycles were performed for each sample. The collected powder was allowed to dry under ambient conditions. Certain samples of the core-shell structures were annealed at 300° C. in either a tube furnace or a muffle furnace. The samples annealed in a tube furnace were annealed under 0.150 SLM Argon atmosphere and with 15 mtorr vacuum while those in the muffle furnace were in ambient air.

Coating of VO₂@SiO₂ Core-Shell Nanowires onto Glass Substrates: Glass slides were cleaned with a piranha solution for 24 h and then washed with nanopure water. The piranha solution was comprised of 150 mL concentrated sulfuric acid and 50 mL of 30% hydrogen peroxide. Core-shell VO₂@SiO₂ nanowires were dispersed in isopropanol using ultrasonication for 10 min. An aliquot of the solution was then removed and sprayed onto a freshly cleaned glass slide using a Master airbrush (G79) with nozzle diameter of 0.8 mm utilizing an air compressor with output pressure of 40 psi. This process was repeated several times to obtain a homogeneous coating on the slides.

In an alternate coating process, the modified Stöber growth process was followed using VO₂ nanowires, TEOS, and NH₄OH dispersed within a water:ethanol mixture. The mixture was allowed to react for 10 min and then a portion was removed and sprayed onto the cleaned glass slide. Again, this process was repeated until a homogeneous coating was made using the entirety of the solution. The mixture interacted with the hydroxylated substrate, forming dispersions of VO₂ nanowires in amorphous silica matrices. In addition, some of the prepared slides were annealed in open air at 100° C. after drying.

The VO₂@SiO₂ core-shell nanowires were characterized using a variety of methods. The surface morphologies were examined using scanning electron microscopy (SEM, Hitachi SU-70 operated at 5 kV and equipped with an energy dispersive X-ray spectroscopy detector). The nanowire/silica shell interfaces were further examined using high-resolution transmission electron microscopy (HRTEM) and selected area electron diffraction (SAED, JEOL-2010, operated with an accelerating voltage of 200 kV and a beam current of 100 mA). The samples for HRTEM were prepared by dispersing the coated VO₂ nanowires in ethanol and placing the solution on a 300-mesh copper grid coated with amorphous carbon. The grid was then allowed to dry under ambient conditions. Raman spectra were obtained using a Jobin-Yvon Horiba Labram HR800 instrument coupled to an Olympus BX41 microscope using the 514.5 nm laser excitation from an Ar-ion laser. The laser power was kept below 10 mW to avoid photo-oxidation. Differential scanning calorimetry (DSC, Q200 TA instruments) measurements under flowing argon atmosphere in a temperature range from −50° C. to 150° C. were used to determine the transition temperature of the prepared nanowires.

Adhesion testing was performed using the American Society for Testing Materials (ASTM) Test 3359. Briefly, a grid was defined on the coated substrate using the designated tool. Tape was then applied to the substrate and peeled. The coating was then classified (0B to 5B) according to the standards prescribed for this ASTM method. FTIR measurements were performed on a Bruker instrument using a thermal stage.

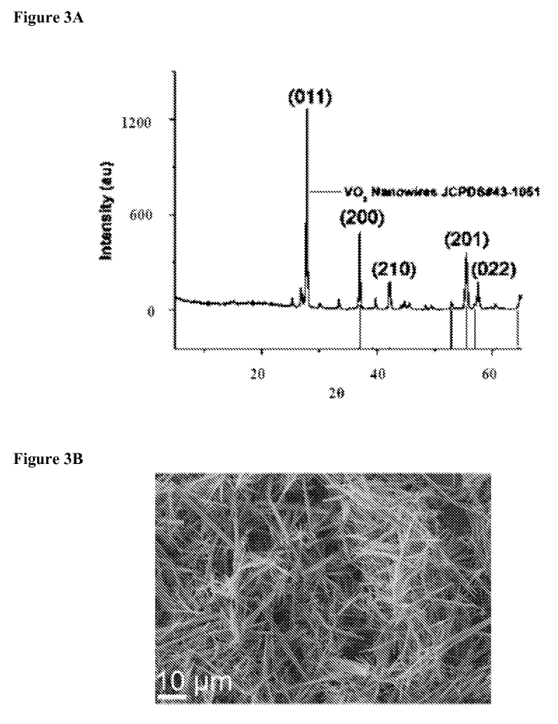

FIG. 3A shows an indexed powder X-ray diffraction pattern of the as-prepared VO₂ nanowires indicating that they are stabilized with the M1 monoclinic crystal structure. FIG. 3B indicates a panoramic SEM image of the nanowires attesting to the high purity of the synthetic process. The nanowires are range in diameter from 20 to 250 nm and can span tens of micrometers in length.

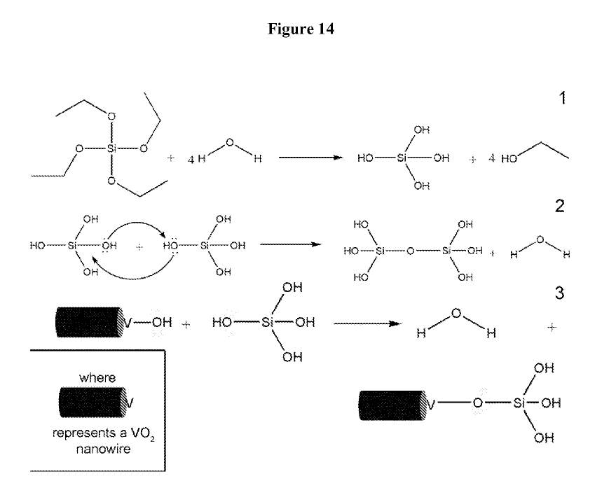

To enhance the chemical and thermal stability of the VO₂ nanowires and to ensure improved adhesion to glass substrates, we encapsulated the nanowires within a SiO₂ shell. SiO₂ is optically transparent in the visible region of the electromagnetic spectrum and is not expected to deleteriously impact the visible light transmittance of the prepared coatings. Furthermore, the SiO₂ shells can be readily functionalized to bind to hydrophilic or hydrophobic surfaces. We have constructed the SiO₂ shells around the VO₂ nanowires using a modified Stöber method based on the hydrolysis of a substituted silane as per FIG. 14 (Scheme 1(Step 1)). Subsequent to hydrolysis of TEOS, the condensation of silicic acid moieties results in the formation of a Si—O—Si linkage (Scheme 1(Step 2)). Continued condensation results in creation of amorphous silica. Under conditions favoring homogeneous nucleation, SiO₂ nanoparticles are obtained, whereas heterogeneous nucleation onto other materials induces the formation of conformal silica shells. For covalent attachment of the silica shells to other metal oxides, the only requisite is the presence of accessible hydroxyl groups on the metal oxide surfaces that can condense with the silicic acid moieties to form, in this case, Si—O—V linkages. Further condensation and polymerization gives rise to the amorphous SiO₂ shell around the VO₂ nanowires (as schematically illustrated in Scheme 1(Step 3)).

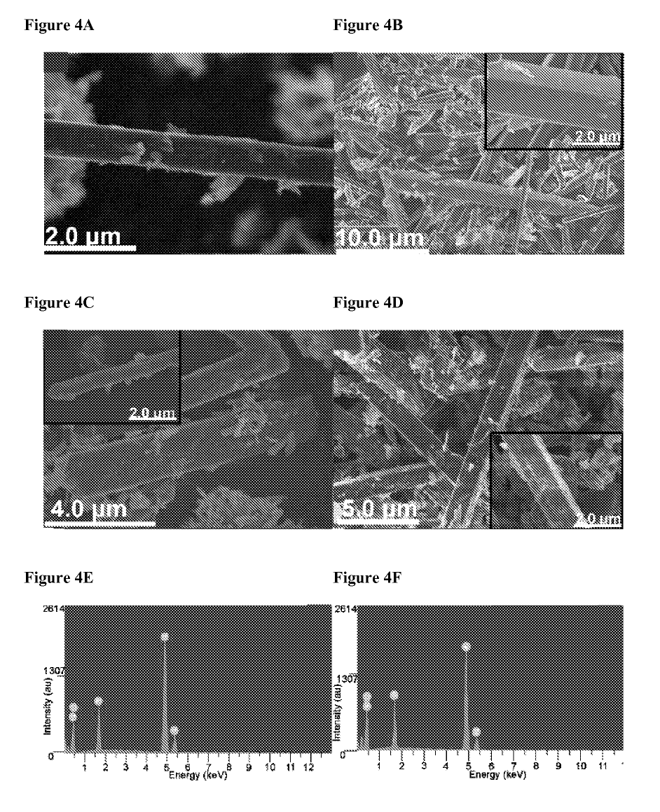

VO₂@SiO₂ nanowires have been synthesized using reaction times of 15, 30, and 60 min. The surface morphologies of the nanowires have been examined by SEM as depicted in FIGS. 4A-4F. No significant difference is discernible for the nanowires reacted with the TEOS precursor for 15 min. However, after reaction for 30 min, the VO₂ nanowires show uneven rough surfaces suggesting the initiation of silica precipitation onto the nanowires. Indeed, energy dispersive X-ray spectroscopy (FIG. 4E) indicates the presence of Si on the nanowire surfaces. Rough surface morphology is seen in the 60 minute coated sample as well. After reaction for 60 min, the inset to FIG. 4D shows clear indications of a deposited overlayer suggesting the formation of a SiO₂ shell.

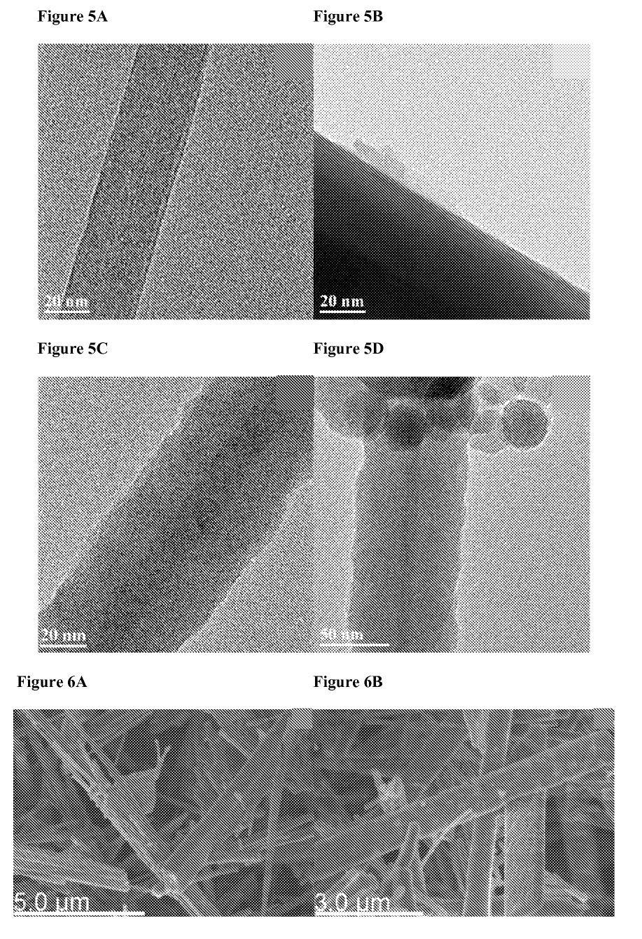

Further corroboration of the growth of a SiO₂ shell around the VO₂ nanowires is derived from TEM examination of the core-shell structures as shown in FIGS. 5A-5D. A complete shell has been observed for VO₂ nanowires reacted for 30 and 60 min, whereas discontinuous silica precipitates are noted on the nanowire surfaces upon reaction for 15 min (FIG. 5B). Increasing the reaction time to 30 min (FIG. 5C) allows for a complete shell to form around the nanowires, which is observed to further grow in thickness with increasing reaction time. The shell is noted to be rough and has a wavy profile as expected for an amorphous layer, which is in stark contrast to the cleanly faceted surfaces of the crystalline VO₂ nanowires. The shell further exhibits a much lower electron density contrast, which is explicable considering the relatively low density of amorphous SiO₂ and the higher atomic mass of the VO₂ core.

In order to study the effectiveness of the SiO₂ shell in protecting the VO₂ nanowires from thermal oxidation, different annealing procedures have been attempted for VO₂ nanowires that are conformally covered with SiO₂ shells of at least 20 nm thickness. The core-shell structures have been annealed at 300° C. in a tube furnace either under an Ar ambient or in a muffle furnace under an air ambient. Notably, it has been reported that annealing uncoated VO₂ nanowires in air at 300° C. results in oxidation of these materials to V₂O₅.

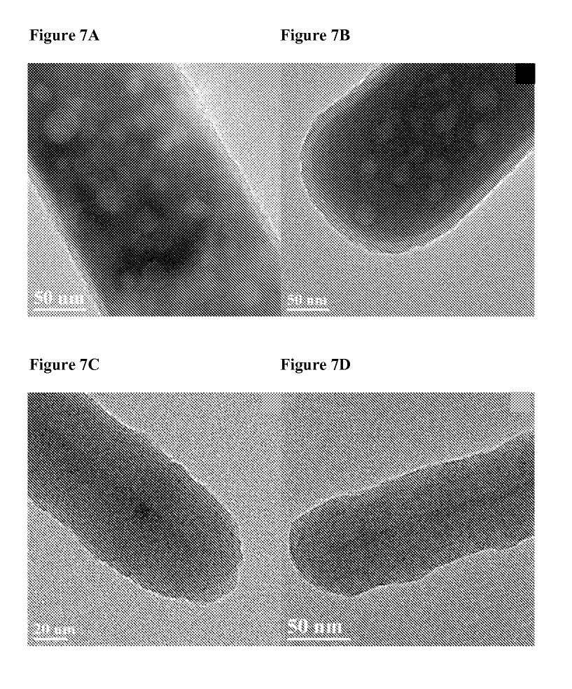

FIGS. 6A-6B show SEM images of samples reacted for 30 min after annealing at 300° C. under air and Ar ambients. Annealing appears to induce some agglomeration of the nanowires, perhaps as a result of increased dehydration, although the nanowires are observed to retain their morphology. FIG. 6B shows the characteristic roughness of the surface of the SiO₂ shell. No appreciable change in Si concentration is evidenced by energy-dispersive X-ray spectroscopy. The TEM images depicted in FIGS. 7A-7D also suggest a slight decrease in the thickness of the SiO₂ shells, which further appear to be better defined. Notably, we have not observed any lattice fringes for the SiO₂ shells before or after annealing attesting to their amorphous nature.

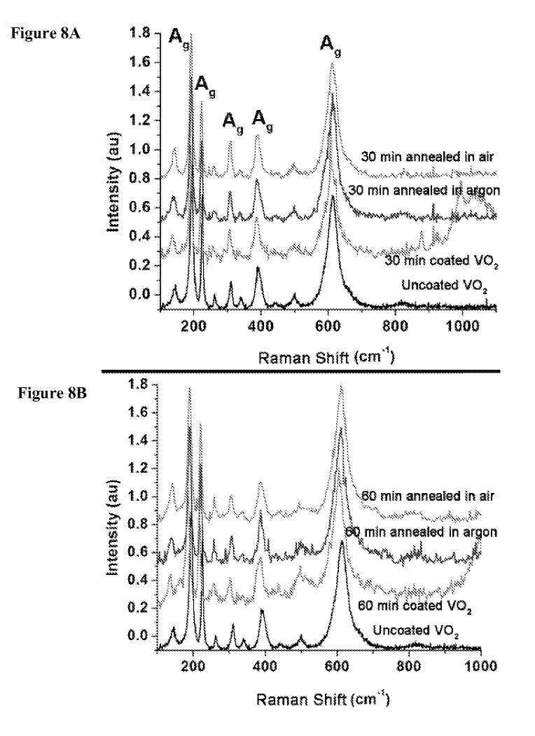

Raman microprobe studies have been performed to evaluate the structural integrity and phase purity of the coated VO₂ nanowires. The M1 phase of VO₂ corresponds to the P2₁/c (C₂ₕ³) space group and indeed group theory analysis predicts the existence of 18 distinctive modes: 9 of Ag symmetry and 9 with B_{g} symmetry. FIGS. 8A-8B indicate the Raman spectra of the annealed samples. The A_{g} and B_{g} modes are observed to be retained for the annealed samples, including upon annealing in air, confirming that the coating and annealing process does not alter the crystal structure of VO₂ nanowire cores. The SiO₂ shells thus clearly increase the robustness of the nanowires towards thermal oxidation.

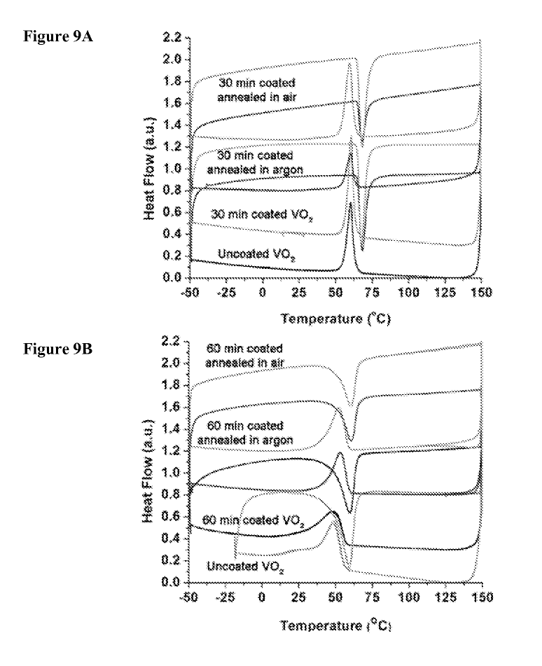

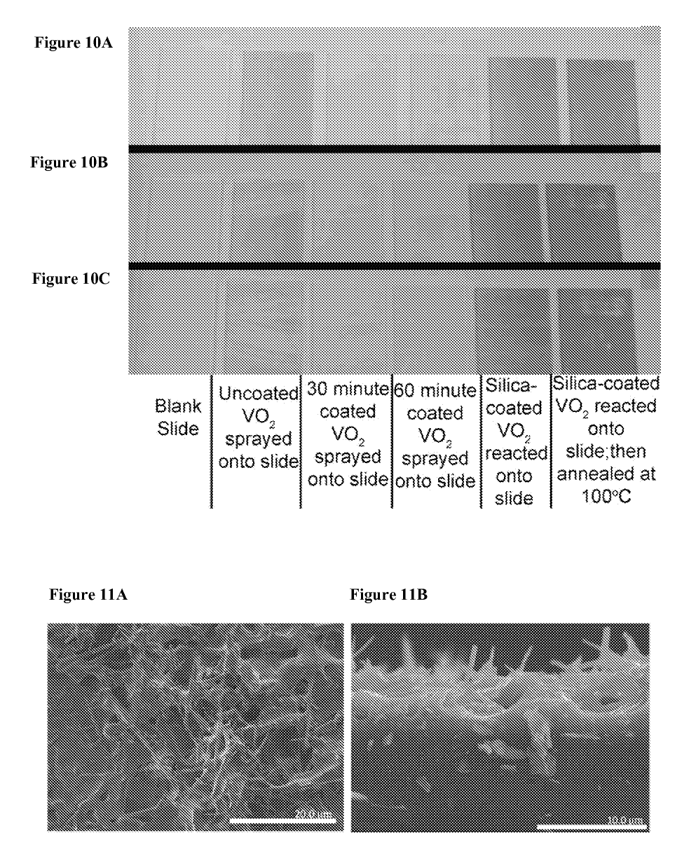

To further evaluate whether the deposition of a SiO₂ shell and subsequent annealing alters the functionality of the VO₂ nanowires, DSC measurements have been used to examine the structural transition temperatures of the core-shell materials (FIGS. 9A-9B). As noted above, the monoclinic→rutile structural transformation is first-order in nature and thus associated with a latent heat of reaction. The bond distortions and the abrupt change in the entropy of the conduction electrons across the phase transition give rise to distinct features in DSC plots. As the nanowires are heated, an endothermic transformation from the monoclinic to the tetragonal phase is visible as a valley in the DSC plot. Subsequently, as the sample is cooled, a pronounced peak corresponding to the exothermic tetragonal to monoclinic transformation is evidenced (FIGS. 9A-9B). Indeed, encapsulation by a SiO₂ shell and subsequent annealing do not appreciably affect the critical transition temperatures of the VO₂ cores, suggesting that the shells can enhance thermal robustness of the VO₂ nanowires without interfering with their functionality. Notably, the amorphous character of the SiO₂ shell implies that it is not epitaxially matched with the crystalline VO₂ nanowire cores, and is further likely to be able to accommodate substantial strain given that the amorphous SiO₂ lattice is not close packed. The ability to coat VO₂ nanowires without subjecting them to deleterious strain effects that can shift the transition temperature represents a major advance for the preparation of thermochromic coatings.

Next, we have deposited the VO₂@SiO₂ nanowires onto glass to evaluate whether the SiO₂ shell can provide improved adhesion. Uncoated VO₂ nanowires have been used as a control and are sprayed onto a freshly cleaned glass slide from 2-propanol dispersions. Two separate methods for depositing core-shell nanowires onto glass have been explored. In the first approach, the core-shell nanowires have been spray-coated onto the glass substrates from 2-propanol dispersions, analogous to the method used for uncoated nanowires. In a second approach, the reaction mixture used for the modified Stöber growth process has been used as the precursor solution for spray-coating. Aliquots of the solution are continually sprayed to achieve the desired thickness. Subsequently, some slides have been annealed at a temperature of 100° C.

To simply test if the adhesion of any of the silica shell-vanadium dioxide nanowires were better than uncoated vanadium dioxide, a simple wipe test was performed. A Kem-wipe was used to wipe the top of the coated slides. Uncoated VO₂ as well as the coated nanowires simply wiped off the glass substrate with minimal pressure. However, the slides that were coated with the reaction mixture had barely any powder wipe off. Most of the coating remained adhered to the glass substrates. All slides were then washed with ethanol to test if adhesion changed at all after washing. The same results were seen as before washing. FIGS. 11A-11B show top-view and cross-sectional SEM images of the VO₂ thin films embedded in SiO₂. The nanowires are seen to be enrobed in amorphous SiO₂.

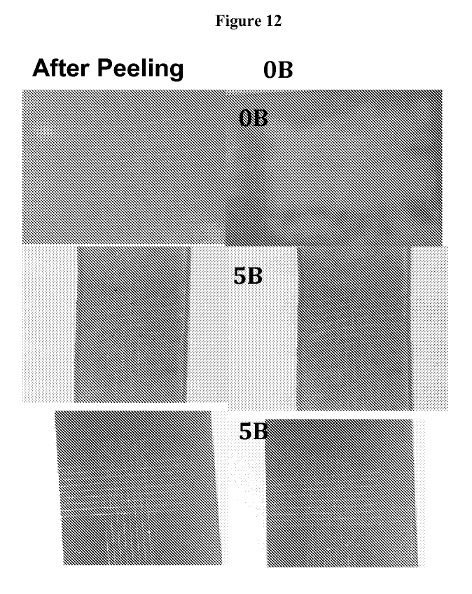

More rigorous testing of adhesion has been performed using ASTM 3359. While VO₂ nanowires spray-coated onto glass are readily removed by applying an adhesive tape to the substrate (FIG. 12, top panels), the VO₂/SiO₂ samples show excellent adhesion with or without annealing and can be classified as 5B, the strongest adhering category by this test.

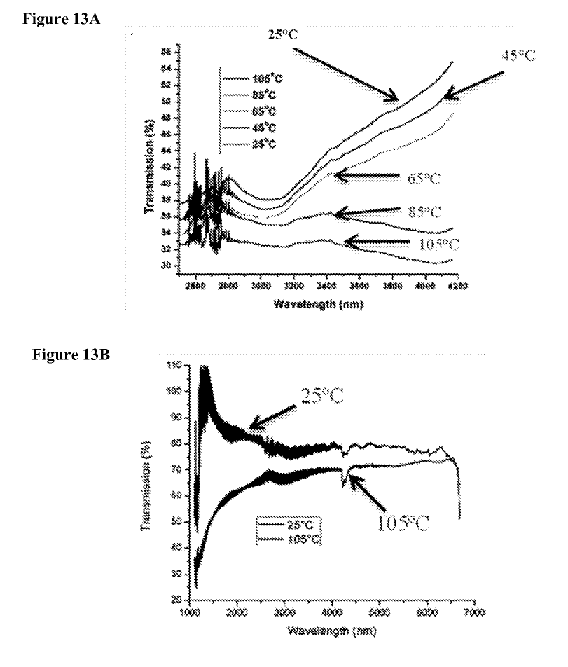

FIGS. 13A-13B show infrared transmittance measured for the VO₂/SiO₂ coatings deposited onto glass cover slips. The sharp diminution of transmittance with increasing temperature is readily visible. FIG. 13B shows a more expansive spectrum and indicates an almost ca. 40% attenuation of infrared transmittance induced by increasing temperature.

In summary, we have shown that a SiO₂ shell can be constituted around VO₂ nanowires using the modified Stöber process. The thickness of the shell can be varied by changing the reaction time. Reaction times of 30 and 60 min result in formation of continuous conformal shells around the nanowires as evidenced by electron microscopy observations. The SiO₂-encapsulated VO₂ nanowires exhibit increased robustness to thermal oxidation. The crystal structure and functionality of the VO₂ core is retained upon encapsulation with the SiO₂ shell and no appreciable modification of the phase transition temperature has been evinced. We have also shown VO₂ nanowires can be dispersed in a SiO₂ matrix using the modified Stöber process followed by application to a substrate. Methods for obtaining excellent adhesion of the nano- or micromaterials to glass substrates have been developed based on 1) shelling VO₂ nano- or micromaterials with amorphous SiO₂ shells or 2) dispersing VO₂ nano- or micromaterials within an amorphous SiO₂ matrix. We have also enhanced the adhesion by hydroxylating the substrate or by selecting a substrate which natively possess a sufficient number of surface hydroxyl groups to bond to the silica shell. Our results suggest the utility of this method for the preparation of energy efficient dynamically switchable glazing. Indeed, the coatings exhibit excellent attenuation of infrared transmittance upon heating past the phase transition temperature.

The preceding description provides specific examples of the present disclosure. Those skilled in the art will recognize that routine modifications to these embodiments can be made which are intended to be within the scope of the present disclosure.

1. A composition comprising a crystalline vanadium oxide nanomaterial and/or micromaterial encapsulated in an amorphous or crystalline oxide, sulfide, or selenide matrix.

2. The composition of claim 1, wherein the vanadium oxide nanomaterial and/or micromaterial is in the form of nanoparticles, microparticle, nanowires, microwires, nanorods, microrods, nanospheres, microspheres, nanostars, microstars, or a combination thereof.

3. The composition of claim 1, wherein the amorphous oxide matrix comprises silicon oxide, titanium oxide, vanadium oxide, zinc oxide, hafnium oxide, cerium oxide, molybdenum oxide, or a combination thereof.

4. The composition of claim 1, wherein the vanadium oxide nanomaterial and/or vanadium oxide micromaterial is doped.

5. A substrate comprising a film of the composition of claim 1 disposed on at least a portion of a surface of the substrate.

6. The substrate of claim 5, wherein the substrate is glass, silicon oxide, sapphire, alumina, polymer, plastic, or indium tin oxide-coated glass.

7. The substrate of claim 5, wherein the film of the composition of claim 1 disposed on the at least a portion of a surface of the substrate has a thickness of 50 nm to 5 microns.

8. The substrate of claim 5, wherein the substrate is part of a window unit, insulating glass unit, or other part of a fenestration component.

9. The substrate of claim 8, wherein the window unit is a double-paned insulating glass unit and the at least a portion of the surface of the substrate is an interior surface of the double-paned insulating glass unit.

10. A method of making a substrate comprising the composition of claim 1 disposed on at least a portion of a surface of the substrate comprising:
a) optionally, forming a plurality of hydroxyl groups on the at least a portion of a surface of the substrate; and
b) contacting the at least a portion of the surface of the substrate with a film forming composition such that the composition of claim 1 is formed on the at a portion of the surface of the substrate; and
c) optionally, repeating b) using the substrate from b) until a desired thickness of the composition of claim 1 is formed on the at least a portion of the surface of the substrate.

11. The method of claim 10, wherein the film forming composition comprises preformed crystalline vanadium oxide nanomaterial and/or vanadium oxide micromaterial encapsulated in an amorphous or crystalline oxide, sulfide, or selenide matrix.

12. The method of claim 10, wherein the film forming composition comprises crystalline vanadium oxide nanomaterial and/or micromaterial, an encapsulating material precursor, a catalyst, and an aqueous solvent.

13. The method of claim 10, further comprising annealing the composition of claim 1 formed on the at least a portion of the surface of the substrate in b) and/or after at least one of the compositions of claim 1 formed on the at least a portion of the surface of the substrate in c).

14. The method of claim 10, wherein the substrate is a glass, silicon oxide, sapphire, alumina, polymer, plastic, or indium tin oxide-coated glass.

15. The method of claim 10, wherein the hydroxyl groups are formed by contacting the at least a portion of the substrate with a hydroxylating solution, ozone, or a plasma comprising a hydroxylating oxidant species.

16. The method of claim 10, wherein the layer of the composition of claim 1 on at least a portion of the surface of the substrate is formed by spray coating, spin coating, roll coating, wire-bar coating, dip coating, powder coating, self-assembly, or electrophoretic deposition.
